(19) United States
(12) Patent Application Publication
(10) Pub. No.: US 2020/0247334 A1
(43) Pub. Date: Aug. 6, 2020

(54) OUTER TRIM OF PILLAR FOR VEHICLE AND MANUFACTURING PROCESS THEREOF

(71) Applicant: SAINT-GOBAIN GLASS FRANCE, COURBEVOIE (FR)

(72) Inventor: Xiaofeng GUO, Shanghai (CN)

(21) Appl. No.: 16/644,073

(22) PCT Filed: Dec. 6, 2018
(86) PCT No.: PCT/CN2018/119507

§ 371 Date: Mar. 3, 2020

(30) Foreign Application Priority Data
Dec. 12, 2017 (CN) 201711316760.3

(51) Int. Cl. B60R 13/04; B29C 45/14; C03C 27/04

(52) U.S. Cl. CPC B60R 13/04; B29C 45/14311; B29K 2709/08; C03C 27/048; B29C 45/14434

(57) ABSTRACT

An outer trim of a pillar for a vehicle which is arranged at a pillar sheet metal of the vehicle, includes a pillar bracket fixedly connected to the pillar sheet metal; and a glass forming an outer decorative face of the outer trim of the pillar, the glass connecting and covering the outer surface of the pillar bracket.

### RELATED FIELD

The present disclosure generally relates to the production of vehicle components, and in particularly to an outer trim of a pillar for a vehicle and a manufacturing process thereof.

### BACKGROUND

In most vehicles, an outer trim of a pillar for a vehicle (A pillar, B pillar, and C pillar) is typically made of a plastic material, such as PC (polycarbonate) and PMMA (polymethyl methacrylate), by injection molding. The plastic outer trim of the pillar is not scratch-resistant and generally cannot satisfy requirements of the user for the appearance of the vehicle. In order to improve the appearance of the outer trim of the pillar for the vehicle, some manufacturers propose to change the material of the outer trim of the pillar or paint/plate the outer surface of the pillar with a coating to improve the glossiness of the outer surface of the pillar. For example, the outer trim of the pillar may be made of PMMA and ABS (acrylonitrile butadiene styrene) by injection molding to obtain a high gloss. Alternatively, a decorative patch made of metal (e.g., stainless steel), which may be adhered to the outer surface of the pillar, is produced by some manufacturers to provide a “glaring” appearance, especially in the sun.

However, none of the above solutions can perfectly satisfy the increasingly strict requirements of the user for the appearance of the pillar. Especially for the outer surface of the pillar facing the outside of the vehicle, both scratch resistance and UV resistance are factors to be considered. Although the injection material of the outer trim of the pillar may be changed to obtain a high gloss, it does not mean that a good scratch resistance may also be obtained. Even if the metal decorative patch is employed, some scratches will unavoidably appear on the metal surface after long-term use and the additional decorative patch inevitably causes increased cost for the user.

### SUMMARY

The object of the present disclosure is to solve the above problems in the prior art, and to provide an outer trim of a pillar for a vehicle. The outer trim of the pillar has UV resistance and improved surface hardness to provide excellent scratch resistance, and allows the pillar to have appearances that can satisfy different user requirements. Another object of the present disclosure is to provide the outer trim of the pillar in a cost-effective manner, such that the outer trim of the pillar is easy to be implemented and widely used.

To this end, according to an aspect of the present disclosure, an outer trim of a pillar for a vehicle is provided. The outer trim of the pillar is arranged at a pillar sheet metal of the vehicle and comprises a pillar bracket fixedly connected to the pillar sheet metal and a glass forming an outer decorative face of the outer trim of the pillar. The glass connects and covers the outer surface of the pillar bracket.

According to the above technical concepts, the present disclosure may further comprise any one or more of the following preferred embodiments.

In some preferred embodiments, the glass is integrated with the pillar bracket by injection molding.

In some preferred embodiments, the glass is bonded to the pillar bracket by an adhesive, or the glass is mechanically connected to the pillar bracket by a snap/hook or a tongue/groove provided on the glass and/or the pillar bracket.

In some preferred embodiments, the glass is ordinary glass, tempered glass, ultra-thin glass, flat glass or curved glass.

In some preferred embodiments, a surface of the glass proximate to the pillar bracket is coated with a primer.

In some preferred embodiments, the surface of the glass proximate to the pillar bracket is coated with an ink layer to form different appearances.

According to another aspect of the present disclosure, a process for manufacturing an outer trim of a pillar for a vehicle is provided. The outer trim of the pillar for the vehicle is arranged at a pillar sheet metal of the vehicle. The process comprises the following steps:

a. providing a cut and shaped glass;

b. placing the glass into a mold and injecting an injection material to form a pillar bracket; and

c. integrating the glass with the pillar bracket into an outer trim of a pillar by injection molding; the pillar bracket is formed with a structure connectable to the pillar sheet metal and the glass forms an outer decorative face of the outer trim of the pillar.

In some preferred embodiments, the manufacturing process further comprises the step of coating the injection surface of the glass with a primer prior to step b.

In some preferred embodiments, the manufacturing process further comprises the step of coating the injection surface of the glass with an ink layer to form different appearances prior to step b.

According to a further aspect of the present disclosure, a process for manufacturing an outer trim of a pillar for a vehicle is provided. The outer trim of the pillar for the vehicle is arranged at a pillar sheet metal of the vehicle. The process comprises the following steps:

a. providing a cut and shaped glass;

b. forming a pillar bracket in a mold by injection molding, the pillar bracket being formed with a structure connectable to the pillar sheet metal; and

c. fixedly connecting the glass to the outer surface of the pillar bracket where the glass forms an outer decorative face of the outer trim of the pillar.

In some preferred embodiments, the glass is bonded to the outer surface of the pillar bracket by an adhesive in step c.

In some preferred embodiments, the glass is mechanically connected to the outer surface of the pillar bracket by a snap/hook or a tongue/groove provided on the glass and/or the pillar bracket in step c.

In some preferred embodiments, the manufacturing process further comprises the step of coating the connection surface of the glass with a primer prior to step c.

In some preferred embodiments, the manufacturing process further comprises the step of coating the connection surface of the glass with an ink layer to form different appearances prior to step c.

Compared with a conventional plastic outer trim of a pillar or a metal decorative patch, the outer trim of the pillar for the vehicle has a higher surface hardness and greatly improved scratch resistance which is not easy to be worn since the glass is used as the outer decorative face of the outer trim of the pillar according to the present disclosure. The outer trim of the pillar would have good UV resistance due to the characteristics of glass material per se, and it can prevent aging and cracking. In addition, it may satisfy the user's requirements for different appearance performances by employing glass with different color and gloss, and it is possible to obtain different appearances by coating the glass with different ink layers. It is easy to implement the connection between the glass and the pillar bracket in the outer trim of the pillar of the present disclosure, which is widely applicable to various occasions.

### BRIEF DESCRIPTION OF THE DRAWINGS

Other features and advantages of the present disclosure will be better understood from the following preferred embodiments described in detail with reference to the accompany drawings, in which:

FIG. 1 is a schematic exploded view of an outer trim of a pillar for a vehicle according to a preferred embodiment of the present disclosure;

FIG. 2 is a schematic view showing the assembly of the outer trim of the pillar for the vehicle in FIG. 1;

FIG. 3 is a sectional view taken along line A-A in FIG. 2;

FIG. 4 is a view similar to FIG. 3, showing another manner of connection between the pillar bracket and the glass; and

FIG. 5 is a view similar to FIG. 3, showing a further manner of connection between the pillar bracket and the glass.

### DETAILED DESCRIPTION

The implementation and usage of the embodiments will be discussed in detail below. However, it should be understood that the specific embodiments discussed herein are merely illustrative of specific ways to implement and use the present disclosure without limiting the scope of the present disclosure. In the description for the structural positions of various components, representations of directions such as “upper”, “lower”, “top” and “bottom” are not absolute, but relative. When the various components are arranged as shown in the drawings, these representations of directions are appropriate. However, when the positions of the various components in the drawings are changed, these representations of directions are also changed accordingly. Besides, “outer” and “inner” used hereinafter are directions with respect to the vehicle body. “Outer” refers to a direction away from the vehicle body, and “inner” refers to a direction facing the vehicle body.

Herein, “glass” refers to a transparent semi-solid and semi-liquid matter which is a silicate non-metallic material. During melting, it forms a continuous network structure. During cooling, its viscosity would be gradually increased and hardened without crystallizing. The major component of ordinary glass is silica (SiO₂). When certain metals or metal oxides or salts are mixed in the glass, the glass can exhibit colors to form colored glass. Besides, tempered glass can also be obtained by a special method. “Plastic” refers to a material which is formed by the polymerization of monomer raw materials via synthesis or condensation reactions, and the major component of the plastic is high molecular polymer. Some transparent plastic (such as polymethyl methacrylate, PMMA) is also referred to as organic glass. “Glass” herein encompasses inorganic glass with silica as its major component, which has high strength, high temperature resistance (generally, its products can keep undeformed at 400 degrees Celsius), aging resistance (less likely to be deformed and faded under ultraviolet light), low cost, heat insulation, sound absorbing, flame retardancy and other characteristics. According to the concept of the present disclosure, an outer trim of a pillar for a vehicle arranged at a pillar sheet metal of the vehicle includes a pillar bracket fixedly connected to the pillar sheet metal and a glass connecting and covering the outer surface of the pillar bracket. The glass forms the outer decorative face of the outer trim of the pillar. In some embodiments, the glass may be integrated with the pillar bracket by injection molding. In some embodiments, the glass may also be connected to the pillar bracket by a pre-installation process, which may include, for example, adhesive bonding or mechanical connection.

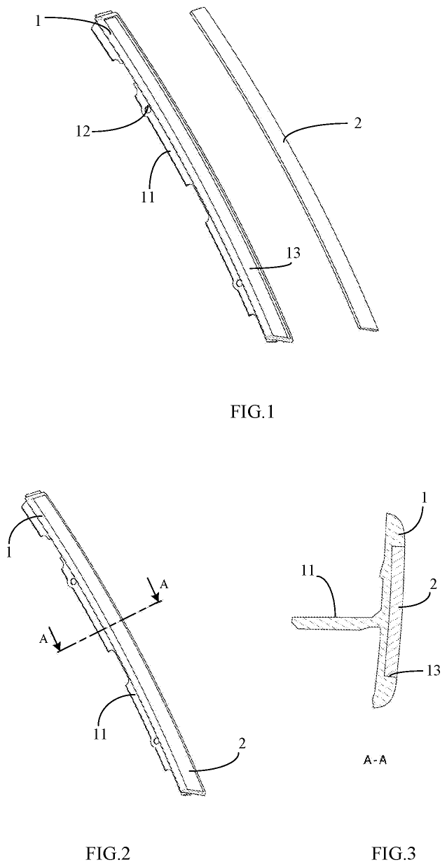

FIGS. 1 to 3 illustrate an outer trim of a pillar for a vehicle according to a preferred embodiment, in which the glass is integrated with the pillar bracket by injection molding.

Referring first to the schematic exploded view shown in FIG. 1, the outer trim of the pillar for the vehicle includes a pillar bracket 1 and a glass 2. The pillar bracket 1 is formed with a connecting structure capable of being connected to a pillar sheet metal (not shown). The connecting structure is, for example, one or more connecting flanges 11 as shown in the drawing, and the connecting flanges 11 are provided with connecting holes 12 to facilitate fixing the pillar bracket 1 to the pillar sheet metal by fasteners such as screws. It can be understood that the pillar bracket 1 may also be attached to the pillar sheet metal by an adhesive or by welding. In addition, although the pillar bracket 1 shown in the drawing is formed with a structure similar to a channel 13, the channel 13 in this embodiment is not pre-formed for fixing the glass 2, and is advantageously formed by the close fit between the glass and molten injection material during the injection molding process of the pillar bracket 1.

In some embodiments, the manufacturing process for integrating the glass 2 with the pillar bracket 1 by injection molding may be performed by the following steps:

First, a cut and shaped glass is provided. The shape of the glass may be varied according to different pillars (A pillar, B pillar or C pillar). For example, the glass 2 shown in FIG. 1 is provided for a middle pillar (B pillar). Advantageously, the glass may also be shaped and sized to cover most part of the outer surface of the pillar bracket to achieve an effective external effect.

Next, the injection surface of the glass is coated with a primer. The primer contributes to improve the adhesive performance between the substrates to be connected. Especially for a high molecular material for forming the pillar bracket, the primer can achieve an excellent effect of increasing adhesive performance.

Then, the glass coated with the primer is placed into a mold and an injection material for forming the pillar bracket is injected into the mold. The injection material includes, for example, engineering plastics, such as PP (polypropylene), ABS, and PMMA.

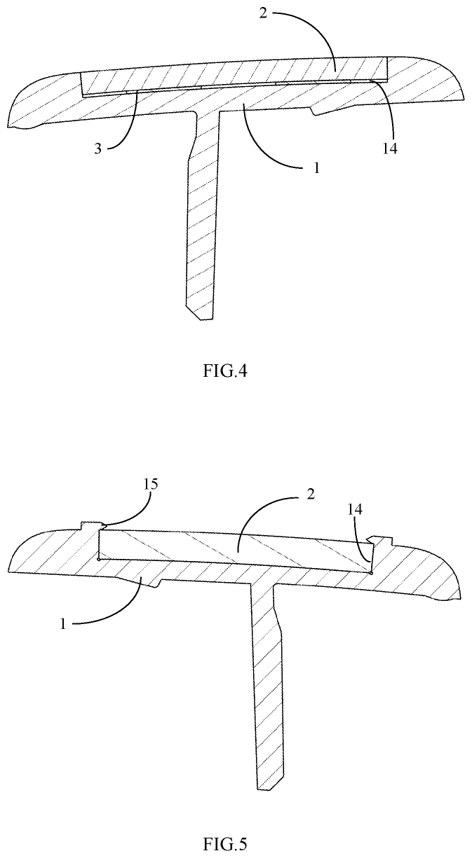

Finally, the glass and the pillar bracket are integrated into an outer trim of a pillar by injection molding. As shown in FIG. 2, during the injection molding process, the pillar bracket 1 is formed with a structure capable of being connected to the pillar sheet metal, and the glass 2 is formed as an outer decorative face of the outer trim of the pillar. As can be seen from the A-A sectional view shown in FIG. 3, the molten injection material bonds the injection surface of the glass 2 and encases the side end faces of the glass 2, thereby achieving a solid connection between the pillar bracket and the glass.

The above glass may be colorless, green, gray or black, etc., which is the color of the glass material per se, to obtain different appearances. In some embodiments, the glass may also be coated with an ink layer. For example, in the manufacturing process for integral formation by injection molding, before the injection surface of the glass is coated with the primer, the glass may be additionally coated with a monochrome or polychromatic ink layer depending on the decoration requirements for the appearance of the vehicle. The ink layer is preferably coated on the injection surface of the glass and exhibits the desired appearance by means of the transparent characteristic of the glass. Besides, the ink layer is less likely to be worn or peeled off, and is durable. In addition, considering the refractive and reflective properties of the glass, the injection surface of the glass may also be coated with a layer of material capable of refracting and reflecting light; alternatively, a glass having high refractive index, such as crystal glass, may be employed to obtain a “glaring” appearance.

As noted above, the glass may also be connected to the pillar bracket by a pre-installation process, which may include, for example, adhesive bonding or mechanical connection. In some embodiments, a cut and shaped glass and an injection-molded pillar bracket are provided respectively, and then the glass is fixedly connected to the pillar bracket to form the outer trim of the pillar. The glass forms the outer decorative face of the outer trim of the pillar.

In an embodiment in which adhesive bonding is employed, as shown in FIG. 4, a slot 14 for accommodating the glass 2 is formed on the adhesion surface of the pillar bracket 1. Then adhesive 3 (for example, 3M adhesive) may be employed to adhere the glass 2 to the adhesion surface of the pillar bracket 1 over a large area. Similarly, before the glass is adhered, the adhesion surface of the glass may be coated with the primer and the monochrome or polychromatic ink layer.

In an embodiment in which mechanical connection is employed, as an example, the glass and/or the pillar bracket may be provided with a snap or hook for connecting the glass to the pillar bracket via snap fit. As shown in FIG. 5, the connection surface of the pillar bracket 1 is formed with a slot 14 for accommodating the glass 2. The top edge of the side wall of the slot 14 is formed with a plurality of collars having hooks 15, so that the glass 2 can be clamped in the slot 14. Alternatively, the glass and/or the pillar bracket may be provided with a tongue/groove structure. For example, the pillar bracket may be formed with a groove, and the glass may be formed with a tongue. The groove may be a straight groove or a dovetail groove, and the tongue may be formed to have a corresponding structure. Similarly, prior to connection, the connection surface of the glass facing the outer surface of the pillar bracket may be coated with the primer and the monochrome or polychromatic ink layer.

In the various embodiments mentioned above, the glass may be selected from ordinary glass, tempered glass, ultra-thin glass, flat glass, curved glass, and the like. It can be understood that the shape, size, material, color and the like of the glass can be changed according to different applications and different requirements for the appearance.

By means of the outer trim of the pillar for the vehicle according to the present disclosure, it is possible to avoid appearance defects on the outer decorative face of the pillar for the vehicle due to bumping or scratching during, for example, car washing and daily use. The outer decorative face of the outer trim of the pillar not only has a high surface hardness, but also has excellent high-temperature resistance and UV resistance, so that the outer decorative face is less likely to be aged, deformed and faded. And various appearances can be obtained according to actual requirements. Besides, compared with most materials, glass itself is cost-effective and easy to process, which has a wide application prospect.

The technical content and technical features of the present disclosure have been disclosed above. However, it should be understood that those skilled in the art can make various variations and improvements to the above disclosed concepts under the inventive idea of the present disclosure, and all these variations and improvements belong to the scope of protection of the present disclosure. The description for the above embodiments is illustrative and not restrictive, and the scope of protection of the present disclosure is determined by the claims.

1. An outer trim of a pillar for a vehicle which is arranged at a pillar sheet metal of the vehicle, the outer trim of the pillar comprising:
a pillar bracket fixedly connected to the pillar sheet metal; and
a glass forming an outer decorative face of the outer trim of the pillar, the glass connecting and covering the outer surface of the pillar bracket.

2. The outer trim of the pillar for the vehicle according to claim 1, wherein the glass is integrated with the pillar bracket by injection molding.

3. The outer trim of the pillar for the vehicle according to claim 1, wherein the glass is bonded to the pillar bracket by an adhesive, or the glass is mechanically connected to the pillar bracket by a snap/hook or a tongue/groove provided on the glass and/or the pillar bracket.

4. The outer trim of the pillar for the vehicle according to claim 2, wherein the glass is ordinary glass, tempered glass, ultra-thin glass, flat glass or curved glass.

5. The outer trim of the pillar for the vehicle according to claim 2, wherein a surface of the glass proximate to the pillar bracket is coated with a primer.

6. The outer trim of the pillar for the vehicle according to claim 5, wherein the surface of the glass proximate to the pillar bracket is coated with an ink layer to form different appearances.

7. A process for manufacturing an outer trim of a pillar for a vehicle which is arranged at a pillar sheet metal of the vehicle, wherein the process comprises the following steps:
a. providing a cut and shaped glass;
b. placing the glass into a mold and injecting an injection material to form a pillar bracket; and
c. integrating the glass with the pillar bracket into an outer trim of a pillar by injection molding, wherein the pillar bracket is formed with a structure connectable to the pillar sheet metal and the glass forms an outer decorative face of the outer trim of the pillar.

8. The process for manufacturing the outer trim of the pillar for the vehicle according to claim 7, further comprising the step of coating the injection surface of the glass with a primer prior to step b.

9. The process for manufacturing the outer trim of the pillar for the vehicle according to claim 8, further comprising the step of coating the injection surface of the glass with an ink layer to form different appearances prior to step b.

10. A process for manufacturing an outer trim of a pillar for a vehicle which is arranged at a pillar sheet metal of the vehicle, wherein the process comprises the following steps:
a. providing a cut and shaped glass;
b. forming a pillar bracket in a mold by injection molding, the pillar bracket being formed with a structure connectable to the pillar sheet metal; and
c. fixedly connecting the glass to the outer surface of the pillar bracket, wherein the glass forms an outer decorative face of the outer trim of the pillar.

11. The process for manufacturing the outer trim of the pillar for the vehicle according to claim 10, wherein the glass is bonded to the outer surface of the pillar bracket by an adhesive in step c.

12. The process for manufacturing the outer trim of the pillar for the vehicle according to claim 10, wherein the glass is mechanically connected to the outer surface of the pillar bracket by a snap/hook or a tongue/groove provided on the glass and/or the pillar bracket in step c.

13. The process for manufacturing the outer trim of the pillar for the vehicle according to claim 11, further comprising the step of coating the connection surface of the glass with a primer prior to step c.

14. The process for manufacturing the outer trim of the pillar for the vehicle according to claim 13, further comprising the step of coating the connection surface of the glass with an ink layer to form different appearances prior to step c.

15. The outer trim of the pillar for the vehicle according to claim 3, wherein the glass is ordinary glass, tempered glass, ultra-thin glass, flat glass or curved glass.

16. The outer trim of the pillar for the vehicle according to claim 3, wherein a surface of the glass proximate to the pillar bracket is coated with a primer.

17. The process for manufacturing the outer trim of the pillar for the vehicle according to claim 12, further comprising the step of coating the connection surface of the glass with a primer prior to step c.
